(19) United States
(12) Patent Application Publication
(10) Pub. No.: US 2006/0001324 A1
(43) Pub. Date: Jan. 5, 2006

(54) Pattern coil type vertical vibrator

(75) Inventors: Sung Hong Won, Sungnam (KR); Seong Pyo Hong, Suwon (KR); Joon Choi, Suwon (KR); Ju Ho Kim, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: SAMSUNG ELECTRO-MECHANICS CO., LTD., Suwon (KR)

(21) Appl. No.: 10/939,372

(22) Filed: Sep. 14, 2004

(30) Foreign Application Priority Data
Jul. 1, 2004 (KR) 2004-50999

(51) Int. Cl. H02K 7/06

(52) U.S. Cl. 310/81

(57) ABSTRACT

Disclosed is a pattern coil type vertical vibrator including: a housing; a magnetic circuit unit placed in the internal space of the housing, and including a magnet perpendicularly placed and a yoke for fixedly receiving the magnet therein; spring members provided with upper ends fixed to the housing and lower ends fixed to the magnetic circuit unit for vertically and elastically supporting the magnetic circuit unit; a vibrating unit, including a weight assembled with the yoke of the magnetic circuit unit, vertically vibrated together with the magnetic circuit unit through the spring members; and a pattern coil, printed on an upper surface of a base for closing a lower surface of the housing, to which power is supplied, so that the pattern coil is interlinked with a magnetic field generated from the magnet and generates force just upwardly when the power is supplied to the pattern coil.

### BACKGROUND OF THE INVENTION

1. Field of the Invention

The present invention relates to a vertical vibrator, and more particularly to a pattern coil type vertical vibrator, in which the pattern of a coil serving as a route for current are printed on a base, thereby reducing the number of required components and the number of steps of a manufacturing process and facilitating the thin profile of products.

2. Description of the Related Art

Generally, sound and vibration are used to inform users of an incoming call. A small-sized vibrating motor is driven to generate vibration, and driving force of the vibrating motor is transmitted to a housing of a device, thereby vibrating the whole portions of the device.

A vibrating motor, which is one incoming call notification means applied to a communication device, such as a cellular phone, converts electrical energy to mechanical energy using the principle of electromagnetic force, and is installed in a cellular phone for informing users of an incoming call without sound.

As the cellular phone market has been rapidly expanding and cellular phones have grown to include many additional functions, components of the cellular phone are developed toward miniaturization and high quality. Accordingly, a vibrating motor having a novel structure, which solves drawbacks of the conventional vibrating motor and has an improved quality, are required now.

FIG. 1 is a cross-sectional view of a conventional coin type vibrating motor. The conventional coin type or flat type vibrating motor 1 comprises a stator 20, a rotor 10 installed rotatably against the stator 20, and a housing 30 accommodating the stator 20 and the rotor 10.

When external power is applied to the vibrating motor 1 through a pair of brushes 25 installed on a lower substrate 21 of the stator 20, currents having different polarities flow along the brushes 25. Since upper ends of the brushes 25 elastically contact a commutator 15 formed on the lower surface of the rotor 10, power is supplied to a wound coil 12 of the rotor 10 through the commutator 15 contacting the brushes 25.

The rotor 10 is rotated in one direction centering on a shaft 31 by interaction between an electric field formed by a direction of the flow of the current induced to the wound coil 12 and a magnetic field formed by a magnet 22 of the stator 20.

Here, contact points between the brushes 25 and segments of the commutator 15 contacting the brushes 25 vary whenever the rotor 10 is rotated, and the polarity of the power is continuously changed. Thereby, the rotor 10 having the eccentric center of gravity is continuously rotated, thus inducing vibration used as a signal expressing the notification of an incoming call.

In FIG. 1, non-described reference numeral 14 represents an insulator surrounding the wound coil 12 and a weight, non-described reference numeral 32 represents a bearing member, and non-described reference numeral 35 represents a base for sealing the opened lower part of the housing 30.

The above vibrating motor 1 generates mechanical vibration by rotating the rotor 10 having a weight eccentrically disposed when external power is supplied to the vibrating motor 1. The rotating force of the rotor 10 is mainly embodied by a commutator or brush type structure of the motor, which supplies current to the coil of the rotor 10 by a commutating action through contact points between the brushes 25 and the commutator 15.

However, when the above-structured vibrating motor 1 is driven, the brushes 25 pass through a space between segments of the commutator 15, thus causing mechanical friction and electrical sparks between the brushes 25 and the segments of the commutator 15 and abrasion of the brushes 25 and the commutator 15, thereby producing foreign substances, such as black powder and shortening the lifespan of the motor.

Accordingly, in order to solve the drawbacks of the conventional commutator or brush type vibrating motor, a multifunctional actuator, serving as means for inducing sound or vertical vibration using the resonant frequency of a vibrometer, has been developed.

FIG. 2 is a cross-sectional view of a conventional multifunctional actuator. As shown in FIG. 2, the actuator 2 comprises a main case 40 having an internal space, a vibrating plate 50 installed on the upper part of the main case 40 and provided with a sound-generating coil 52 generating sound according to a signal source, installed on the lower surface thereof, a magnet 60 vertically installed in the main case 40 and provided with an upper plate 62 mounted on the upper surface thereof for forming a magnetic circuit, the upper plate 62, a weight 65 constituting a vibrating body together with a yoke 64 mounting the magnet thereon, a plate spring 66 for elastically supporting the vibrating body in the main case 40, and a vibration-generating coil 42, placed just below the vibrating body, for generating vibration.

In FIG. 2, non-described reference numeral 45 represents an upper case for closing the upper part of the main case 40, and non-described reference numeral 44 represents a base provided with the vibration-generating coil 42 mounted thereon.

The actuator 2 supplies external power to the sound-generating coil 52 or the vibration-generating coil 42 through a lead wire (not shown), thereby selectively generating sound and vibration. When power is supplied to the sound-generating coil 52, the vibrating plate 50 is finely vibrated by interaction between a magnetic field generated from a magnetic circuit constituted by the magnet 60, the upper plate 62 and the yoke 64 and an electric field generated from the sound-generating coil 52, thereby generating sound.

On the other hand, when power is supplied to the vibration-generating coil 42, the vibrating body, including the magnet 60, the upper plate 62, the yoke 64 and the weight 65, which is suspended by the plate spring 66, is vertically vibrated by interaction between the magnetic field generated from the magnetic circuit including the magnet 60, the upper plate 62 and the yoke 64 and an electric field generated from the vibration-generating coil 42.

Here, the vibrating degree of the vibrating body varies according to the intensity and frequency of a signal for generating the vibration. In case that vertical vibrating width of the vibrating body is larger than a predetermined value, the vibrating body contacts the sound-generating coil 52 serving as an upper structure or the vibration-generating coil 42 serving as a lower structure, thus generating a touch tone. For this reason, as shown in FIG. 2, magnetic bodies 70, serving as dampers absorbing impact when the vibrating body contacts the lower structure, are placed on the lower surface of the yoke 64.

The actuator 2 requires a large number of components and has a complicated structure, thus limiting miniaturization and simplification of products and increasing production costs.

Accordingly, in order to solve the above problems of the actuator 2, a vertical vibrator 3, which requires a small number of components and generates vertical vibration, has been developed.

FIG. 3 is a cross-sectional view of a conventional vertical vibrator. As shown in FIG. 3, the vertical vibrator 3 comprises a case 81 having an internal space with a designated volume, a magnet 82 vertically installed therein, a spring member 86 installed between the housing 81 and a yoke 84 for vibrating a vibrating body, which includes the yoke mounting the magnet 82 thereon and a weight 85 installed on the outer part of the yoke 84 and constitutes a magnetic circuit together with the magnet 82, and a vibration-generating coil 87 placed on the upper surface of a base 88 closing the lower part of the housing 81.

When power is supplied to the vibration-generating coil 87, a magnetic flux, which is the flow of a magnetic field (B) generated from the magnetic circuit constituted by the magnet 82 and the yoke 84, is generated from the lower surface of the magnet 82 and coupled with the vibration-generating coil 87, thereby forming a route flowing toward the lower end of the yoke 84. The vibrating body, which includes the magnet 82, the yoke 84 and the weight 85 and is suspended by the spring member 86 in the housing 81, is vertically vibrated by interaction between a magnetic field of the magnetic circuit and an electric field of the vibration-generating coil 87.

Conventionally, in order to install the vibration-generating coil 87 on the upper surface of the base 88, a worker fixes the vibration-generating coil 87, which was wound in a cylindrical shape in a separate working line, to the base 88, and then solders or bonds the vibration-generating coil 87 using a bonding agent to a lead wire (not shown). Here, the worker must carefully and accurately perform the above coil-assembling step such that the center of the vibration-generating coil 87 coincides with a concentric circle of the yoke 84 and the verticality of the vibration-generating coil 87 coincides with that of a vertical shaft passing through the center of the yoke 84.

In this case, since the step of soldering/bonding the vibration-generating coil 87 to the upper surface of the base 88 and the step of coinciding the concentric circle and verticality of the vibration-generating coil 87 to those of a magnetic circuit are complicated, worker's burden increases, thereby raising production costs of final products and deteriorating productivity.

Further, in order to ensure the stable vertical vibrating width of the vibrating body including the weight 85, the vertical vibrator 3 must be designed in consideration of the height (h) of the vibration-generating coil 87 fixed to the base 88. Accordingly, the thickness of the vertical vibrator 3 is limited.

Since the vertical vibrating width of the vibrating body in the limited inner space of the housing 81 must be designed in consideration of the height (h) of the vibration-generating coil 87 fixed to the base 88, it is difficult to obtain a sufficient degree of vibration of the vibrating body.

### SUMMARY OF THE INVENTION

Therefore, the present invention has been made in view of the above problems, and it is an object of the present invention to provide a pattern coil type vertical vibrator, which reduces the number of components and the number of steps of a manufacturing process to reduce production costs, and has a thin thickness to facilitate the miniaturization of products.

It is another object of the present invention to provide a pattern coil type vertical vibrator, which maximizes a vertical vibrating width of a vibrating unit to obtain a sufficient amount of the vibration of the vibrating unit.

In accordance with the present invention, the above and other objects can be accomplished by the provision of a pattern coil type vertical vibrator comprising: a housing defining an internal space having designated dimensions; a magnetic circuit unit placed in the internal space of the housing, and including a magnet perpendicularly placed and a yoke for fixedly receiving the magnet therein; spring members provided with upper ends fixed to the housing and lower ends fixed to the magnetic circuit unit for vertically and elastically supporting the magnetic circuit unit; a vibrating unit, including a weight assembled with the yoke of the magnetic circuit unit, vertically vibrated together with the magnetic circuit unit through the spring members; and a pattern coil, printed on an upper surface of a base for closing a lower surface of the housing, to which power is supplied, so that the pattern coil is interlinked with a magnetic field generated from the magnet and generates force just upwardly when the power is supplied to the pattern coil.

Preferably, an injection hole may be formed through the upper surface of the housing so that a damping magnetic fluid is injected into the housing and deposited onto the spring members.

Further, preferably, a lower plate magnetized by the magnetic force of the magnet may be installed on the lower surface of the magnet.

Moreover, preferably, the weight may be made of a nonmagnetic material having a high specific gravity, which is not magnetized by the magnetic force of the magnet.

Preferably, the magnetic circuit unit may include a yoke inserted into a central hole formed through a central portion of the weight, and a magnet assembled into an opening of the yoke.

More preferably, the outer surface of the weight may be spaced from the inner surface of the housing by a designated gap.

Preferably, the magnetic circuit unit may include a yoke provided with an opening for receiving the weight, and a magnet inserted into a central hole formed through a central portion of the weight.

More preferably, the outer surface of the yoke may be spaced from the inner surface of the housing by a designated gap.

Preferably, the pattern coil may be electrically connected to positive and negative lead wires, to which external power is supplied.

Further, preferably, the pattern coil may be electrically connected to positive and negative terminals for surface mounting, of which the patterns are printed on the lower surface of the base.

Moreover, preferably, the pattern coil may be a conductor having a scroll shape, of which the pattern is printed on the upper surface of the base.

Preferably, the base may include a multi-layered substrate having at least two ceramic sheets, each sheet provided with a pattern coil printed on the upper surface thereof, and a plurality of via holes formed through the ceramic sheets vertically stacked to electrically connect the pattern coils.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view of a conventional coin type vibrating motor;

FIG. 2 is a cross-sectional view of a conventional multifunctional actuator;

FIG. 3 is a cross-sectional view of a conventional vertical vibrator;

FIGS. 4a and 4b illustrate a pattern coil type vertical vibrator in accordance with a first embodiment of the present invention, and more specifically:

FIG. 4a is a cross-sectional view of the pattern coil type vertical vibrator, which is provided with a lower plate; and

FIG. 4b is a cross-sectional view of the pattern coil type vertical vibrator, which is not provided with the lower plate;

FIG. 5 is an exploded perspective view of the pattern coil type vertical vibrator in accordance with the first embodiment of the present invention;

FIG. 6 is a cross-sectional view of a pattern coil type vertical vibrator in accordance with a second embodiment of the present invention;

FIG. 7 is an exploded perspective view of the pattern coil type vertical vibrator in accordance with the second embodiment of the present invention; and

FIGS. 8a and 8b illustrate another example of a base provided in the pattern coil type vertical vibrator of the present invention, and more specifically:

FIG. 8a is a longitudinal-sectional view of the above example of the base; and

FIG. 8b is an exploded perspective view of the above example of the base.

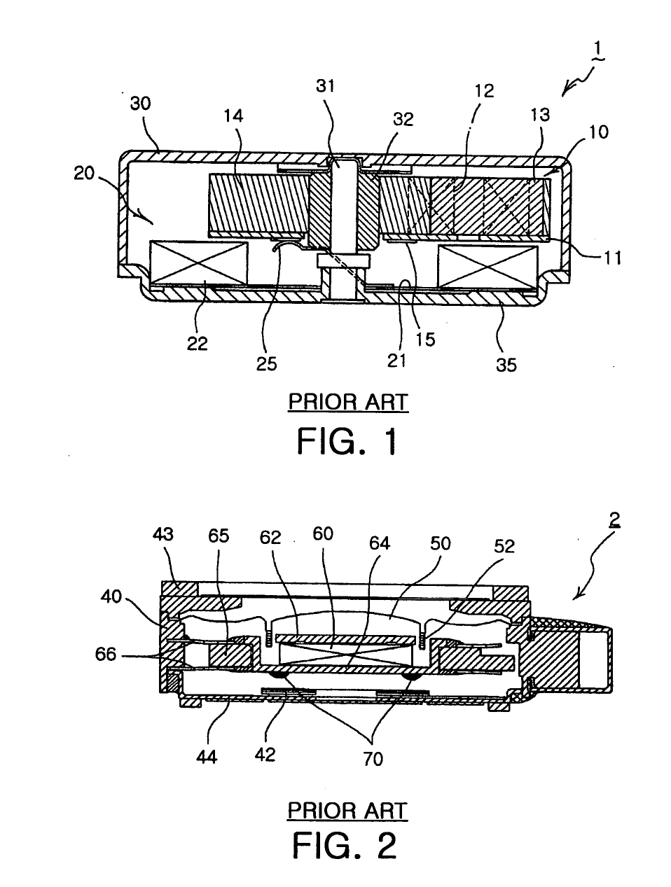

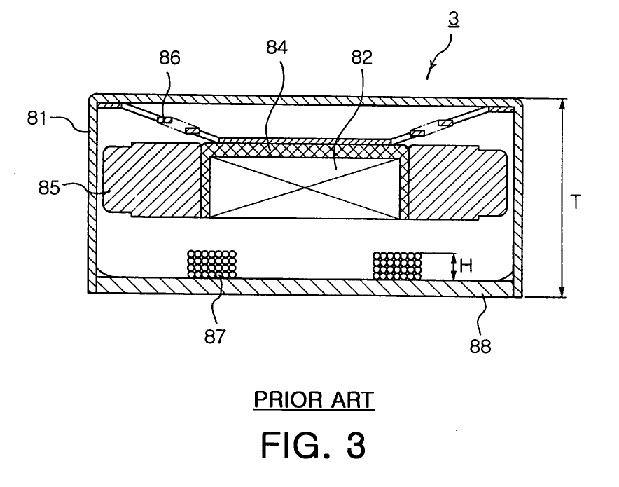

### DESCRIPTION OF THE PREFERRED EMBODIMENTS

Now, preferred embodiments of the present invention will be described in detail with reference to the annexed drawings.

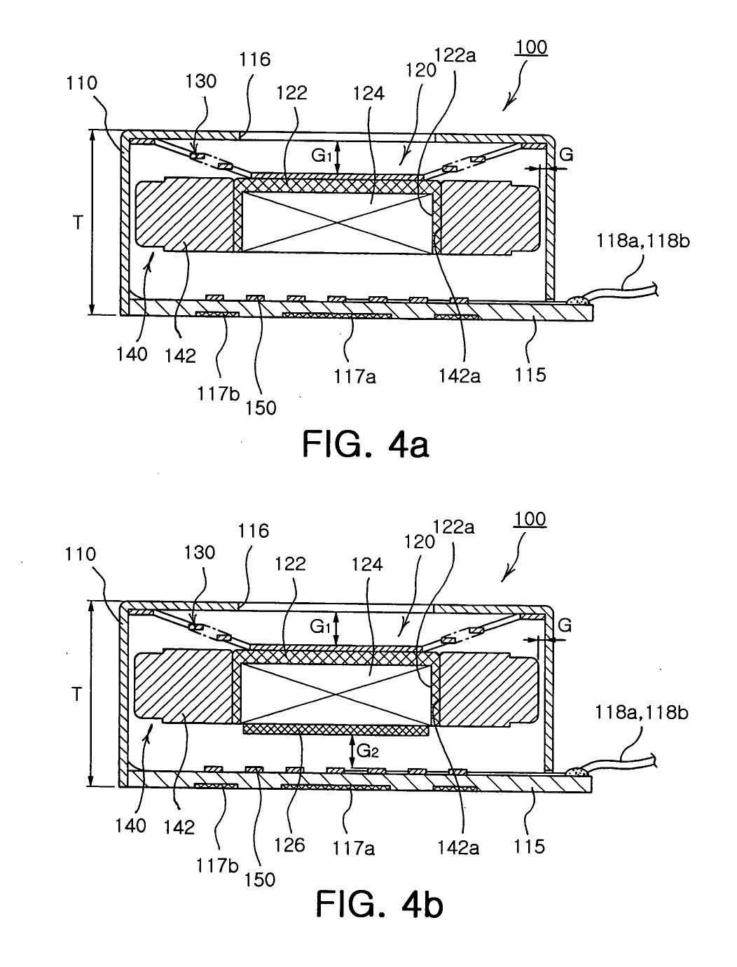

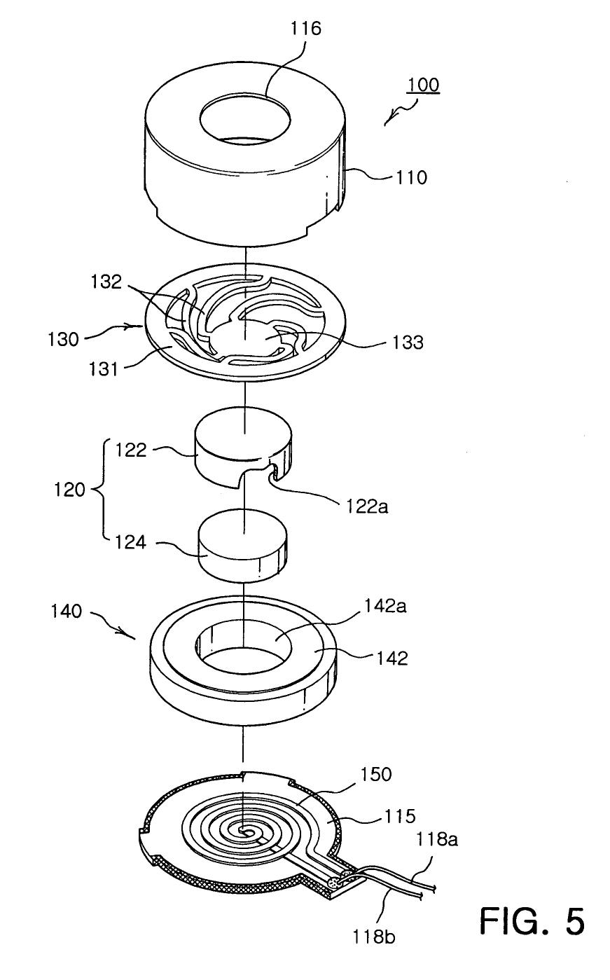

FIGS. 4a and 4b illustrate a pattern coil type vertical vibrator in accordance with a first embodiment of the present invention, and FIG. 5 is an exploded perspective view of the pattern coil type vertical vibrator in accordance with the first embodiment of the present invention.

As shown in FIGS. 4a and 4b and FIG. 5, the vertical vibrator in accordance with the first embodiment of the present invention comprises a housing 10, a magnetic circuit unit 120, spring members 130, a vibrating unit 140, a pattern coil 150 formed on a base for generating force interlinked with a magnetic field, thereby reducing the number of components and the number of steps of an assembling process, having a thin thickness, and maximizing a vertical vibrating width in a limited space.

That is, the housing 110 having a hollow cylindrical structure serves as a receiving member having a designated internal space such that an upper surface of the housing 110 is closed and a lower surface of the housing 110 is opened and sealed by a base 115.

The magnetic unit 120 includes a yoke 122 and a magnet 124, which are disposed inside the housing 110 to generate a magnetic field having a designated intensity. The yoke 122 has an approximately hollow cylindrical structure such that an upper surface of the yoke 122 is closed and a lower surface of the yoke 122 is opened.

The magnet 124 is a permanent magnet having a cylindrical structure, and vertically arranged such that N and S poles of the magnet 124 are longitudinally polarized. The magnet 124 is fixedly inserted into an opening 122a of the yoke 122.

A weight 142 having a hollow cylindrical structure, which is spaced from the inner surface of the housing 110 so that the weight 142 is vertically vibrated without interference with the housing 110, is placed on the outer surface of the yoke 122. The magnet 124 and the weight 142 are assembled with the yoke 122.

As shown in FIG. 4b, the upper surface of a lower plate 126 made of a magnetic material is attached to the lower surface of the magnet 124 by a bonding material so that the lower plate 126 is magnetized by magnetic force of the magnet 124.

The spring members 130, which are placed between the housing 110 and the magnetic circuit unit 120, serve as elastic means for vertically elastically supporting the vibrating unit 140 including the magnetic circuit unit 120.

As shown in FIG. 5, each of the spring members 130 includes a fixed ring 131 having a disk shape fixed to the closed lower surface of the housing 110, a plurality of elastic legs 132 provided with ends connected to the fixed ring 131 and bent from the ends in a spiral shape for generating elastic force, and a fixed disk 133, connected to the other ends of the elastic legs 132 and provided with a lower surface fixed to the center of the upper surface of the yoke 122 of the magnetic circuit unit 120.

Accordingly, an upper gap (G1), in which the vibrating unit 140 is vertically vibrated by the magnetic circuit unit 120 and the weight of the vibrating unit 140, correspondingly to the sagging length of the spring member 130 is formed between the housing 110 and the magnetic circuit unit 120.

The vibrating unit 140, which is vertically vibrated by the spring members 130, includes the hollow cylindrical weight 142 installed together with the magnet 124 inserted into the opening 122a of the yoke 122. A central hole 142a is formed through the central portion of the weight 142, and the yoke 122 of the magnetic circuit unit 120 is inserted into the central hole 142a of the weight 142.

The weight 142 has a hollow cylindrical structure having the central hole 142a formed through the central portion thereof so that the outer surface of the weight 142 is spaced from the inner surface of the housing 110 by a designated gap (G).

The weight 142 integrally assembled with the yoke 122 is a nonmagnetic body, which is not magnetized by magnetic force of the magnet 124 inserted into the opening 122a of the yoke 122, and is made of a material having a high specific gravity, such as tungsten, for increasing vertical vibrating efficiency.

Thereby, a magnetic field generated from the magnet 124 and the lower plate 126 installed on the lower surface of the magnet 124 forms a route of a magnetic flux, which flows toward the upper surface of the magnet 124 through the lower end of the yoke 122 surrounding the magnet 124.

The pattern coil 150 is printed on the upper surface of the base 115 closing the opened lower surface of the housing 110 accommodating the magnetic circuit unit 120, the spring members 130 and the vibrating unit 140 so that the pattern coil 150 is interlinked with the magnetic field generated from the magnet 124 of the magnetic circuit unit 120.

The pattern coil 150 has a scroll shape such that the outer diameter from the center to the outer periphery gradually increases, and is made of a conductive material, of which the pattern is printed on the upper surface of the base 110.

Current from an external power source flows along the pattern coil 150 in one direction, interlinked with the magnetic field of the magnet 124, such that the magnetic field interacts with an electric field, generated when power is supplied to the vibrating vibrator 100, so as to vertically vibrate the vibrating unit 140 including the magnetic circuit unit 120.

As shown in FIGS. 4a and 4b, positive and negative lead wires 118a and 118b, to which external power is supplied, are electrically connected to the front and rear ends of the pattern coil 150 on the upper surface of the base 115. In this case, the vertical vibrator 100 having the positive and negative lead wires 118a and 118b is bonded to a main substrate (not shown).

Further, the patterns of positive and negative terminals 117a and 177b for surface mounting, which are electrically connected to both ends of the pattern coil 150, are patterned on the lower surface of the base 115. In this case, the vertical vibrator 100 is mounted on the surface of the main substrate (not shown) by allowing the positive and negative terminals 117a and 117b to correspond to a power supply unit formed on the main substrate.

Preferably, the pattern coil 150 is printed on the upper surface of the base 115 such that the outer diameter of the pattern coil 159 reaches the outer surface of the yoke 122 mounted in the central hole 142a of the weight 142 so as to ensure a sufficient region in which the magnetic field and the electric field are interlinked with each other.

In this case, the magnetic field generated from the lower surface of the magnet 124 is interlinked with the pattern coil 150, along which current flows in one direction, when the current flows toward the upper surface of the magnet 124 through the lower end of the yoke 122 surrounding the magnet 124, thereby generating a force for vertically vibrating the vibrating unit 140 including the magnetic circuit unit 120.

A lower gap (G2), which is formed between the lower surface of the magnetic circuit unit 120 and the upper surface of the pattern coil 150, has a designated size sufficient to prevent the contact between the weight 142 and the pattern coil 150 when the vibrating unit 140 is vertically vibrated.

At least one injection hole 116 having a designated size is formed through the upper surface of the housing 110, and a damping magnetic fluid (not shown) for preventing the direct contact between the housing 110 and the magnetic circuit unit 120 when the vibrating unit 140 is vertically vibrated is injected through the injection hole 116 and applied to the spring members 130.

Then, the injection hole 116 is safely sealed by a tape member (not shown), on which a label is printed, thereby preventing the magnetic fluid from being leaked out.

The magnetic fluid is obtained by dispersing magnetic powder in a liquid into a colloidal state and adding a surface active agent to the colloidal mixture so that the magnetic powder is not precipitated or cohered by the force of gravity or the magnetic field, and, for example, is a fluid obtained by dispersing fine particles of triiron tetroxide or iron-cobalt alloy in oil or water, or a fluid obtained by dispersing particles of cobalt in toluene. These magnetic powders are ultrafine particles of a diameter of 0.01˜0.02 μm, which exhibit Brownian motion, and the concentration of the magnetic powders in the fluid is uniformly maintained even though an external magnetic field, gravity or centrifugal force is applied to the fluid.

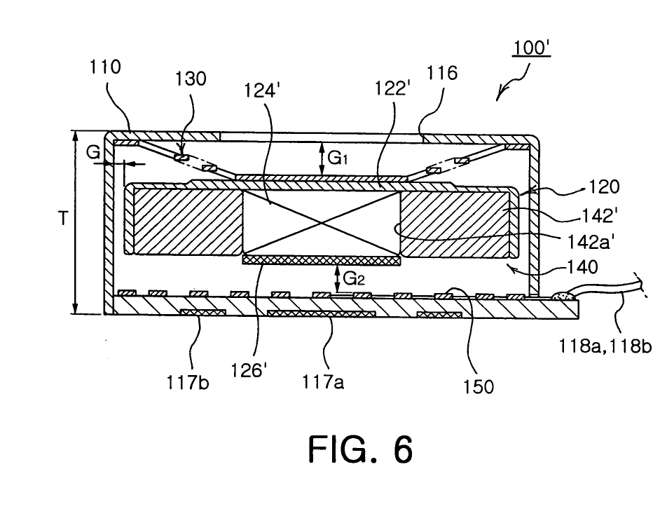

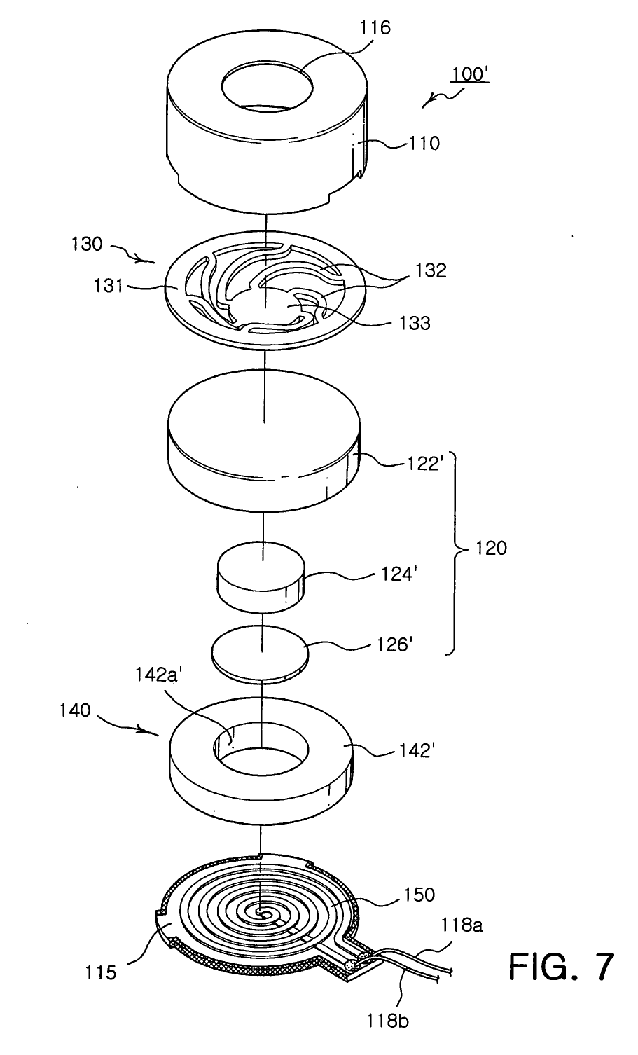

FIG. 6 is a cross-sectional view of a pattern coil type vertical vibrator in accordance with a second embodiment of the present invention, and FIG. 7 is an exploded perspective view of the pattern coil type vertical vibrator in accordance with the second embodiment of the present invention.

In the vertical vibrator 100′ as shown in FIGS. 6 and 7, a yoke 122′ of the magnetic circuit unit 120 elastically supported by the spring members 130 in the housing 110 is extended to the inner surface of the housing 110, and a weight 142′ having a hollow cylindrical structure provided with a magnet 124′ is placed in an opening 122a′ of the yoke 122′.

That is, the weight 142′ provided with a central hole 142a′ is fixedly inserted into and fixed to the opening 122a′ of the yoke 122′ having the extended outer diameter by a bonding agent so that a designated gap is formed between the inner surface of the housing 110 and the outer surface of the yoke 122′.

Since the cylindrical magnet 124′ for generating a magnetic field having a designated intensity is inserted into and fixed to the central hole 142a′ of the weight 142′ by a bonding agent, the magnetic circuit unit 120 including the yoke 122′ and the magnet 124′ and the vibrating unit 140 including the weight 142′ are integrally installed in the housing 110 so that the magnetic circuit unit 120 and the vibrating unit 140 are vertically vibrated in the housing 110 by the spring members 130.

Further, the pattern coil 150, which is interlinked with the magnetic field generated from the magnet 124′ and generates force just upwardly when power is supplied to the vertical vibrator 110′, is printed on a designated position, corresponding to the magnetic circuit unit 120, of the upper surface of the base 115.

Since the outer diameter of the pattern coil 150 is extended to the outer surface of the yoke 122′ having the outer diameter extended to the inner surface of the housing 110, the magnetic field generated from the lower surface of the magnet 122′ is interlinked with the pattern coil 150, along which the current flows in one direction, and is then guided to the lower end of the yoke 122′ having the extended outer diameter surrounding the weight 142′ made of a non-magnetic material, thereby forming a magnetic flux flowing toward the upper part of the magnet 124′.

Here, since a region, in which the magnetic field of the magnet 124′ and the pattern coil 150 having the outer diameter extended to the outer surface of the yoke 122′ having the outer diameter extended so that the weight 142′ is inserted into the opening 122a′ of the yoke 122′, is increased, the vertical vibrator 100′ has an increased vibrating power for vertically vibrating the vibrating unit 140 including the magnetic circuit unit 120.

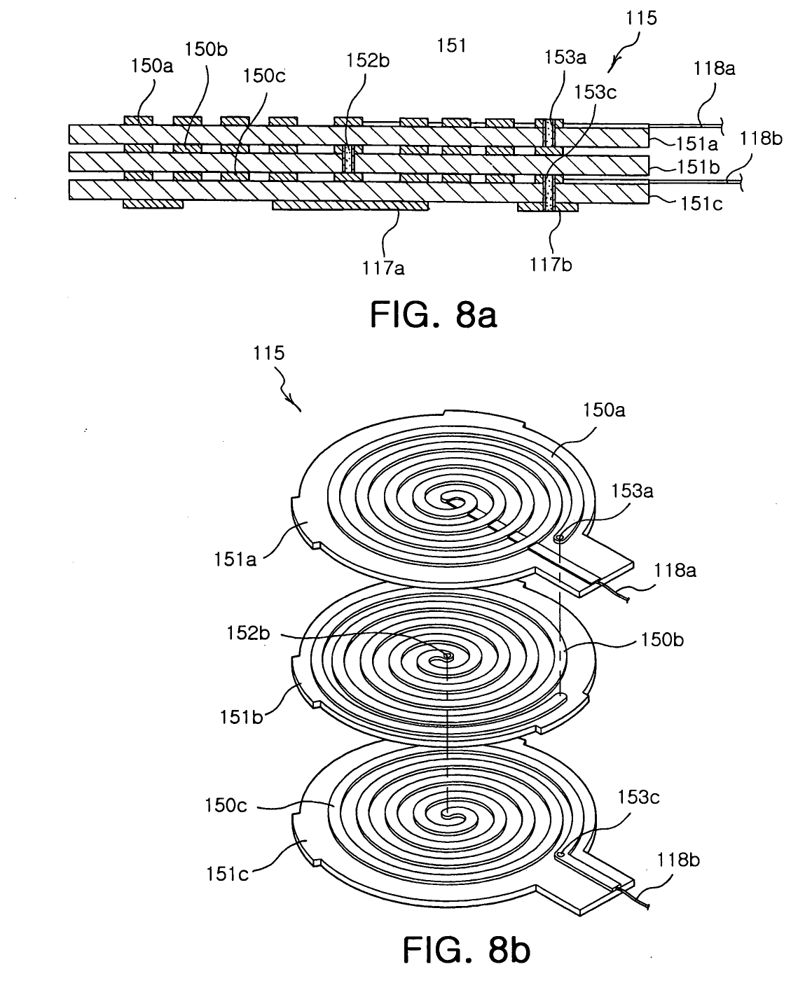

FIGS. 8a and 8b illustrate another example of a base provided in the pattern coil type vertical vibrator of the present invention. More specifically, FIG. 8a is a longitudinal-sectional view of the above example of the base, and FIG. 8b is an exploded perspective view of the above example of the base.

The base 115 of the vertical vibrator 100 or 100′ of the present invention as shown in FIGS. 8a and 8b, includes a multi-layered substrate having at least two ceramic sheets 151a, 151b and/or 151c, and a plurality of via holes 152b, 153a and 153c formed through the ceramic sheets 151a, 151b and 151c vertically stacked to electrically connect pattern coils 150a, 150b and 150c formed on the ceramic sheets 151a, 151b and 151c.

Thereby, the pattern coils 150a, 150b and 150c, printed on the vertically stacked ceramic sheets 151a, 151b and 151c are electrically interconnected in series by the via holes 152b, 153a and 153c, and are connected to positive and negative lead wires 118a and 118b or positive and negative terminals 117a and 117b. Accordingly, the power is supplied to the base 115, and current flows along the multi-layered substrate in one direction.

When external power is supplied to the pattern coil 150 of the vertical vibrator 100 or 100′ through the positive or negative lead wire 118a or 118b or the positive or negative terminal 117a or 117b, an electric field is formed around the pattern coil 150 by the current flowing from one end of the pattern coil 150 to the other end of the pattern coil 150.

In case that the base 115 includes a plurality of ceramic sheets 151a, 151b and 151c provided with the pattern coils 150a, 150b and 150c printed on the upper surface thereof, the pattern coils 150a, 150b and 150c constitute a series circuit through the via holes 152b, 153a and 153c, thereby forming an electric field around the pattern coils 150a, 150b and 150c by the current flowing from one ends of the pattern coils 150a, 150b and 150c to the other ends of the pattern coils 150a, 150b and 150c.

As shown in FIGS. 4a and 4b and FIG. 5, the magnetic circuit unit 120, elastically supported in the internal space of the housing 110 by the spring members 130, includes the yoke 122 inserted into the central hole 142a formed through the central portion of the weight 142, and the magnet 124 assembled into the opening 122a of the yoke 122, and a gap (G) having a designated length is formed between the outer surface of the weight 142 and the inner surface of the housing 110.

Alternately, as shown in FIGS. 6 and 7, the magnetic circuit unit 120 includes the yoke 122′ provided with the opening 122a′ for receiving the hollow cylindrical weight 142′, and the magnet 124′ inserted into the central hole 142a′ formed through the central portion of the weight 142′, and a gap (G) having a designated length is formed between the outer surface of the yoke 122′ and the inner surface of the housing 110.

In this state, the magnetic field generated from the magnet 124 or 124′ flows outwardly from the center(s) of the pattern coil 150 or the pattern coils 150a, 150b and 150c, is simultaneously interlinked with the pattern coil 150 or the pattern coils 150a, 150b and 150c printed on the base 115, and flows toward the upper surface of the magnet 124 contained in the yoke 122 through the lower end of the yoke 122 inserted into the central hole 142a of the weight 142, as shown in FIGS. 4a and 4b, or the upper surface of the magnet 124′ inserted into the central hole 142a′ of the weight 142′, as shown in FIG. 6.

Here, based on Fleming's left hand law, in which, when a left hand is spread such that the thumb, the first finger and the second finger are perpendicular, the first finger points in the direction of the magnetic field, the second finger points in the direction of the current and the thumb points in the direction of the force, the pattern coil 150 or the pattern coils 150a, 150b and 150c generates force for vertically vibrating the vibrating unit 140 including the magnetic circuit unit 120.

In case that the pattern coil 150 or the pattern coils 150a, 150b and 150c is extended to the outer surface of the yoke 122′ extended to surround the weight 142′, the region(s) of the pattern coil 150 or the pattern coils 150a, 150b and 150c interlinked with the magnetic field flowing in a spiral direction along the upper surface of the base 115 is extended, thereby extending a region for generating the force for vertically vibrating the vibrating unit 140 and increasing the vibrating power of the vertical vibrator 100′.

As described above, the vibrating unit 140 including the magnetic circuit unit 120 is vertically vibrated in a predetermined width by the force generated due to the interlinkage between the magnetic field generated from the magnetic circuit unit 120 and the pattern coil 150 or the pattern coils 150a, 150b and 150c, and the vertically vibrating width of the vibrating unit 140 is determined by the elastic force of the spring members 130 elastically supporting the vibrating unit 140.

Here, the pattern coil 150 or the pattern coils 150a, 150b and 150c generating the force for vertically vibrating the vibrating unit 140 including the magnetic circuit unit 120 is (are) printed on the upper surface of the base 115 when the base 115 is manufactured. Accordingly, compared to a conventional vibration-generating coil 87 having a designated height (H) soldered or bonded to the base 88, the pattern coil 150 or the pattern coils 150a, 150b and 150c reduce(s) the overall height of the housing 110, thereby facilitating the manufacture of a thin vertical vibrator having a reduced overall thickness (T).

Otherwise, the upper and lower gaps (G1 and G2) in the limited internal space of the housing 110 correspond to the height of the overall height of the conventional vibration-generating coil 87, thereby increasing the vertically vibrating width of the vibrating unit 140 and allowing the vibrating unit 140 to obtain a sufficient vibrating amount.

As described above, the present invention provides a pattern coil type vertical vibrator, in which the pattern of a coil for generating a force applied in a vertical direction by interaction with a magnetic field of a magnetic circuit unit is printed on a base, thereby omitting a step of soldering/bonding a separate coil on the base and reducing the number of required components. Accordingly, it is possible to reduce production costs of the vertical vibrator and improve manufacturing efficiency of the vertical vibrator.

Further, since the height of the housing is designed in consideration of the height of the pattern coil, the pattern coil type vertical vibrator of the present invention has an overall thin thickness compared to the conventional vertical vibrators.

Moreover, since a vibrating unit of the pattern coil type vertical vibrator of the present invention ensures a vertical vibrating width to correspond to the height of the conventional coil, it is possible to increase the vertical vibrating width of the vibrating unit, thereby allowing the vibrating unit to have sufficient vibration.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A pattern coil type vertical vibrator comprising:
a housing defining an internal space having designated dimensions;
a magnetic circuit unit placed in the internal space of the housing, and including a magnet perpendicularly placed and a yoke for fixedly receiving the magnet therein;
spring members provided with upper ends fixed to the housing and lower ends fixed to the magnetic circuit unit for vertically and elastically supporting the magnetic circuit unit;
a vibrating unit, including a weight assembled with the yoke of the magnetic circuit unit, vertically vibrated together with the magnetic circuit unit through the spring members; and
a pattern coil, printed on an upper surface of a base for closing a lower surface of the housing, to which power is supplied, so that the pattern coil is interlinked with a magnetic field generated from the magnet and generates force just upwardly when the power is supplied to the pattern coil.

2. The pattern coil type vertical vibrator as set forth in claim 1,
wherein an injection hole is formed through the upper surface of the housing so that a damping magnetic fluid is injected into the housing and deposited onto the spring members.

3. The pattern coil type vertical vibrator as set forth in claim 1,
wherein a lower plate magnetized by the magnetic force of the magnet is installed on the lower surface of the magnet.

4. The pattern coil type vertical vibrator as set forth in claim 1,
wherein the weight is made of a nonmagnetic material having a high specific gravity, which is not magnetized by the magnetic force of the magnet.

5. The pattern coil type vertical vibrator as set forth in claim 1,
wherein the magnetic circuit unit includes a yoke inserted into a central hole formed through a central portion of the weight, and a magnet assembled into an opening of the yoke.

6. The pattern coil type vertical vibrator as set forth in claim 5,
wherein the outer surface of the weight is spaced from the inner surface of the housing by a designated gap.

7. The pattern coil type vertical vibrator as set forth in claim 1,
wherein the magnetic circuit unit includes a yoke provided with an opening for receiving the weight, and a magnet inserted into a central hole formed through a central portion of the weight.

8. The pattern coil type vertical vibrator as set forth in claim 7,
wherein the outer surface of the yoke is spaced from the inner surface of the housing by a designated gap.

9. The pattern coil type vertical vibrator as set forth in claim 1,
wherein the pattern coil is electrically connected to positive and negative lead wires, to which external power is supplied.

10. The pattern coil type vertical vibrator as set forth in claim 1,
wherein the pattern coil is electrically connected to positive and negative terminals for surface mounting, of which the patterns are printed on the lower surface of the base.

11. The pattern coil type vertical vibrator as set forth in claim 1,
wherein the pattern coil is a conductor having a scroll shape, of which the pattern is printed on the upper surface of the base.

12. The pattern coil type vertical vibrator as set forth in claim 1,
wherein the base includes a multi-layered substrate having at least two ceramic sheets, each sheet provided with a pattern coil printed on the upper surface thereof, and a plurality of via holes formed through the ceramic sheets vertically stacked to electrically connect the pattern coils.
